(19) United States
(12) Patent Application Publication
(10) Pub. No.: US 2016/0300393 A1
(43) Pub. Date: Oct. 13, 2016

(54) VIRTUAL TRIAL-FITTING SYSTEM, VIRTUAL TRIAL-FITTING PROGRAM, VIRTUAL TRIAL-FITTING METHOD, AND STORAGE MEDIUM IN WHICH VIRTUAL FITTING PROGRAM IS STORED

(71) Applicant: Yasuo KINOSHITA, Hyogo (JP)

(72) Inventor: Yasuo KINOSHITA, Hyogo (JP)

(21) Appl. No.: 15/100,547

(22) PCT Filed: Jan. 23, 2015
(86) PCT No.: PCT/JP2015/051763

§ 371 Date: May 31, 2016

(30) Foreign Application Priority Data
Feb. 27, 2014 (JP) 2014-036150

(51) Int. Cl. G06T 19/00; G06Q 30/06; G06T 13/40; G06F 17/30

(52) U.S. Cl. CPC G06T 19/006; G06F 17/30601; G06F 17/30274; G06F 17/30867; G06Q 30/0643; G06T 13/40; G06T 2210/16

(57) ABSTRACT

A virtual trial-fitting system includes a trial-fitting person information acquisition unit that acquires trial-fitting person information, a motion data acquisition unit that acquires motion data, a motion data deformation unit that deforms the motion data to be adapted to three-dimensional body shape data of a trial-fitting person based on a positional relationship between a feature point in the motion data and a feature point set on the three-dimensional body shape data of one trial-fitting person, an motion body shape data generation unit that generates motion body shape data obtained by moving the three-dimensional body shape data of the trial-fitting person in a three-dimensional manner based on the deformed motion data, a clothes data acquisition unit that acquires clothes data, and a trial-fitting image generation unit that generates a trial-fitting image obtained by putting clothes on the three-dimensional body shape data at each of times of the motion body shape data based on the clothes data.

### BACKGROUND OF THE INVENTION

The present invention relates to a virtual trial-fitting technique for virtually trying on clothes.

With the recent development of the Internet and a mobile telephone network (hereinafter generically referred to as a communication line), shopping via the communication line (hereinafter referred to as Internet shopping) has been becoming popular. Generally, in the Internet shopping, a user selects a desired commodity from among a plurality of commodities displayed on a screen, and the selected commodity is ordered.

If such Internet shopping is used, the user can do shopping without going out to a shop where commodities are being sold. Therefore, the user does shopping without seeing real commodities.

On the other hand, when the user purchases clothes or the like, the user may try-on the clothes to confirm whether the clothes look good on him/her and confirm coordinates or the like with other clothes. However, in the Internet shopping, the user cannot naturally try-on the clothes. Therefore, the user may regret, after purchasing the clothes, the purchase. To solve such a problem, a virtual trial-fitting technique has been proposed.

In Japanese Patent Application Laid-Open No. 2004-086662, a body shape representative point is set from as captured image of a user, clothes drawing data is processed to suit a user's body shape based on the body shape representative point, and the processed clothes drawing data is overlaid on an image of the user and displayed. In Japanese Patent Application Laid-Open No. 2005-216034, first and second feature points for characterizing the body shape at the front and the side of an object are extracted from an object image, a third feature point for characterizing a form of a commodity is extracted from a commodity image, and the commodity image is synthesized with the object image based on the feature points.

On the other hand, in Japanese Patent Application Laid-Open No. 2005-256232, clothing data is scaled based on a state of a marker attached to a human body, and is displayed. In Japanese Patent Application Laid-Open No. 2006-249618, clothes data including a three-dimensional shape or the like of clothes, three-dimensional body shape data of a trial-fitting person, and a plurality of posture data of the trial-fitting person are stored, posture data of the trial-fitting person in each of moving images of the trial-fitting person is estimated, time series posture data is generated from the posture data, movement of the clothes is estimated based on the time series posture data or the like, and image data of the clothes generated based on the estimated movement of the clothes is synthesized with the trial-fitting person in the moving image.

### SUMMARY OF INVENTION

### Technical Problem

If techniques discussed in these Patent Literatures are used, clothes can be virtually tried on. However, In Japanese Patent Application Laid-Open No. 2004-086662 and Japanese Patent Application Laid-Open No. 2005-216094, a two-dimensional image of clothes is synthesized with a two-dimensional image of a trial-fitting person. Therefore, confirmation can only be performed from a fixed viewpoint and cannot be performed from a different viewpoint. On the other hand, in Japanese Patent Application Laid-Open No. 2005-256232 and Japanese Patent Application Laid-Open No. 2006-249618, virtual trial-fitting is performed in a three-dimensional manner. Therefore, confirmation can be performed from a different viewpoint. However, in Japanese Patent Application Laid-Open No. 2005-256232 and Japanese Patent Application Laid-Open No. 2006-249618, a trial-fitting state based on a motion of a trial-fitting person himself/herself previously acquired can only be confirmed. Therefore, the degree of freedom of the motion is low, and a sufficient trial-fitting state cannot be confirmed.

The present invention has been made in view of the foregoing issue, and is directed to enhancing the degree of freedom of a motion in a three-dimensional virtual trial-fitting technique.

In one preferred embodiment of a virtual trial-fitting system according to the present invention, the virtual trial-fitting system includes a trial-fitting person information storage unit storing trial-fitting person information including three-dimensional body shape data of a trial-fitting person and a position of a feature point set on the three-dimensional body shape data, a motion data storage unit storing motion data representing a three-dimensional position of a feature point of a human body at each of times, a clothes data storage unit storing clothes data including shape data of the clothes, a trial-fitting person information acquisition unit that acquires the trial-fitting person information, a motion data acquisition unit that acquires the motion data, a motion data deformation unit that deforms the motion data at each of the times to be adapted to the three-dimensional body shape data of the trial-fitting person based on a positional relationship between the feature point in the motion data at the time and the feature point set on the three-dimensional body shape data of the trial-fitting person, an motion body shape data generation unit that generates motion body shape data obtained by moving the three-dimensional body shape data of the trial-fitting person in a three-dimensional manner based on the deformed motion data, a clothes data acquisition unit that acquires the clothes data from the clothes data storage unit, and a trial-fitting image generation unit that generates a trial-fitting image obtained by putting the clothes on the three-dimensional body shape data at each of the times of the motion body shape data based on the clothes data.

In this configuration, the motion data is deformed to be adapted to the three-dimensional body shape data of the trial-fitting person, and the motion body shape data is generated based on the deformed motion data and the three-dimensional body shape data. If the motion data is generated based on a motion of a model or the like, therefore, the motion body shape data obtained by the trial-fitting person himself/herself having performing the motion can be generated. Three-dimensional shape data of the clothes is virtually put on this motion body shape data. Therefore, the trial-fitting person, himself/herself can confirm a trial-fitting state in performing a predetermined motion. That is, in this configuration, the motion data can be generated from an motion of a third person. Therefore, trial-fitting states in various motion states can be confirmed.

Various methods can be used for the processing for deforming the motion data. In the one preferred embodiment of the virtual trial-fitting system according to the present invention, the motion data deformation unit moves the position of the feature point in the corresponding motion data based on a distance between the adjacent feature points among the feature points set on the three-dimensional body shape data of the trial-fitting person.

In the one preferred embodiment of the virtual trial-fitting system according to the present invention, the trial-fitting person information includes identification information about a person to be permitted to perform an operation for generating the trial-fitting image by the trial-fitting person, and the virtual trial-fitting system further includes an identification information acquisition unit that acquires identification information about a user, and a control unit that performs control to permit the operation for generating the trial-fitting image only for the trial-fitting person information including the identification information about the user as the identification information about the person to be permitted.

In this configuration, a user of the virtual trial-fitting system can perform an operation for generating a trial-fitting image of a third person. However, the operation is permitted only when the user is permitted to perform the operation for generating the trial-fitting image from the trial-fitting person. Therefore, a trial-fitting image of an unspecified third person can be prevented from being generated.

According to the one preferred embodiment of the virtual trial-fitting system according to the present invention, the virtual trial-fitting system includes a group information storage unit storing group information for defining information about the trial-fitting persons belonging to the same group, the trial-fitting person information acquisition unit acquires the trial-fitting person information about the trial-fitting persons belonging to the same group, respective motions of a plurality of persons are defined in the motion data, and the trial-fitting image generation unit generates the trial-fitting images respectively including virtual trial-fitting states of the trial-fitting persons belonging to the same group.

In this configuration, a single trial-fitting image can include respective virtual trial-fitting states of the plurality of trial-fitting persons. Thus, total coordinates for the plurality of persons can be confirmed.

In preferred embodiment of a virtual trial-fitting program for a virtual trial-fitting system for causing a trial-fitting person to virtually trial-fitting clothes in the present invention, the virtual trial-fitting program causes a computer to implement a trial-fitting person information acquisition function for acquiring, from a trial-fitting person information storage unit storing trial-fitting person information including three-dimensional body shape data of the trial-fitting person and a position of a feature point set on the three-dimensional body shape data, the trial-fitting person information, a motion data acquisition function for acquiring, from a motion data storage unit storing motion data representing a three-dimensional position of a feature point of a human body at each of times, the motion data, a motion data deformation function for deforming the motion data at each of the times to be adapted to the three-dimensional body shape data of the trial-fitting person, based on a positional relationship between the feature point in the motion data at the time and the feature point set on the three-dimensional body shape data of the trial-fitting person, an motion body shape data generation function for generating motion body shape data obtained by moving the three-dimensional body shape data of the trial-fitting person in a three-dimensional manner based on the deformed motion data, and a clothes data acquisition function for acquiring the clothes data from a clothes data storage unit storing clothes data including shape data of the clothes, and a trial-fitting image generation function for generating a trial-fitting image obtained by putting the clothes on the three-dimensional body shape data in each of frames of the motion body shape data based on the clothes data. Naturally, an additional feature configuration of the aforementioned virtual trial-fitting system can also be added to this virtual trial-fitting program. Therefore, a similar function and effect are produced.

In preferred embodiment of a virtual trial-fitting method for causing a trial-fitting person to virtually trial-fitting clothes in the present invention, the virtual trial-fitting method includes a trial-fitting person information acquisition step of acquiring trial-fitting person information including previously stored three-dimensional body shape data of the trial-fitting person and a position of a feature point set on the three-dimensional body shape data, a motion data acquisition step of acquiring previously stored motion data representing a three-dimensional position of a feature point of a human body at each of times, a motion data deformation step of deforming the motion data at each of the times to be adapted to the three-dimensional body shape data of the trial-fitting person based on a positional relationship between the feature point in the motion data at the time and the feature point set on the three-dimensional body shape data of the trial-fitting person, an motion body shape data generation step of generating motion body shape data obtained by moving the three-dimensional body shape data of the trial-fitting person in a three-dimensional manner based on the deformed motion data, a clothes data acquisition step of acquiring previously stored clothes data including shape data of the clothes, and a trial-fitting image generation step of generating a trial-fitting image obtained by putting the clothes on the three-dimensional body shape data in each of frames of the motion body shape data based on the clothes data. Naturally, an additional feature configuration of the aforementioned virtual trial-fitting system can also be added to this virtual trial-fitting method. Therefore, a similar function and effect are produced.

### BRIEF DESCRIPTION OF THE DRAWINGS

FIG. 1 is a configuration diagram of a virtual trial-fitting system.

FIG. 2 is a functional block diagram of virtual trial-fitting systems in embodiments 1 and 2.

FIG. 3 is a diagram illustrating a structure of data stored in a server.

FIG. 4 is a flowchart illustrating the flow of processing of the virtual trial-fitting system in the embodiment 1.

FIG. 5 illustrates an example of a selection screen of data used for virtual trial-fitting.

FIG. 6 is a diagram illustrating a graph structure of feature points on three-dimensional body shape data.

FIG. 7 is a diagram illustrating a graph structure of feature points on motion data.

FIG. 8 is a functional block diagram of a virtual trial-fitting system in an embodiment 3.

FIG. 9 illustrates an example of trial-fitting person information and group information in the embodiment 3.

### DETAILED DESCRIPTION OF THE INVENTION

Embodiments of a virtual trial-fitting system according to the present invention will be described below with reference to the drawings. The virtual trial-fitting system generates an image obtained by virtually putting clothes having a three-dimensional shape on three-dimensional body shape data. The virtual trial-fitting system can be configured as a part of an Internet selling system of clothes, although not described in detail below. An Internet communication selling system can be constructed if configured to perform trial-fitting using the aforementioned virtual trial-fitting system and transmit ordering data for clothes that a user liked to an order-receiving server (not illustrated), for example. When such an Internet communication selling system is used, the user can purchase clothes without going into a real shop. Therefore, a person who feels it troublesome or difficult to go into a real shop can also purchase clothes.

### Embodiment 1

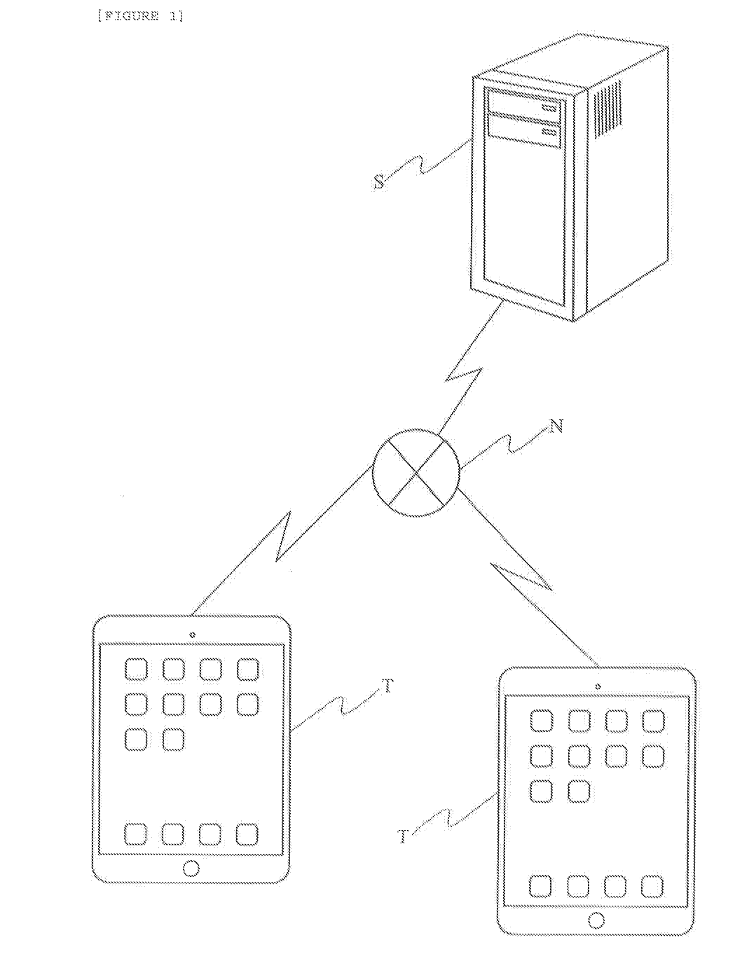

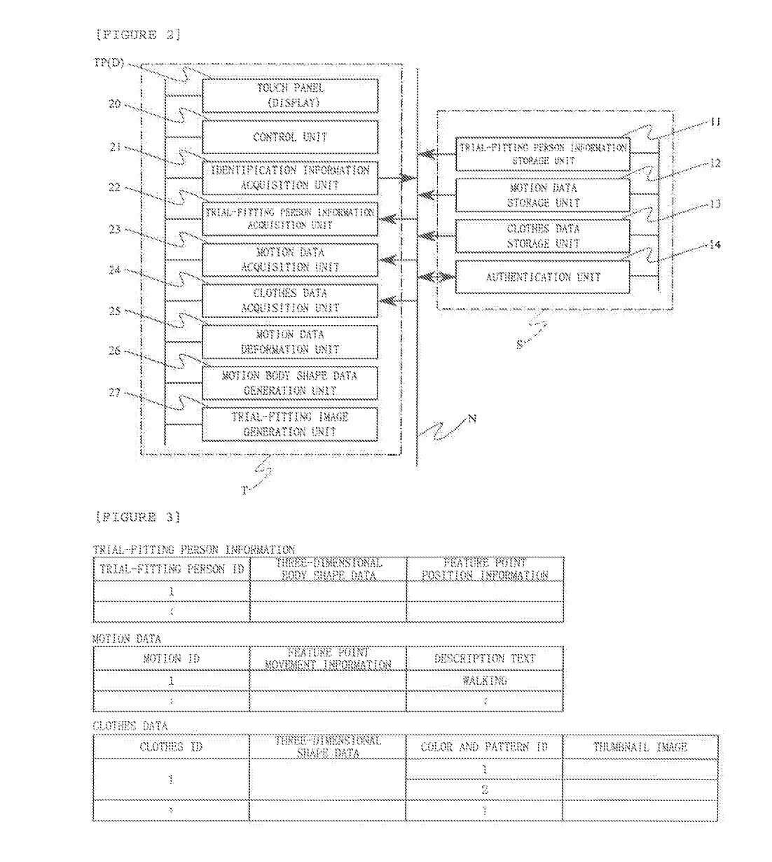

FIGS. 1 and 2 are respectively a configuration diagram and a functional block diagram of a virtual trial-fitting system in the present embodiment. As illustrated in the figures, in the virtual trial-fitting system in the present embodiment, a server S and a communication terminal T are connected to each other via a network N. The server S is configured by a general-purpose computer. When a program for a server in the virtual trial-fitting system is installed into the general-purpose computer, the server S is configured. On the other hand, the communication terminal T can also be configured by a general-purpose computer. However, in the present embodiment, the communication terminal T is configured by a portable network device such as a so-called smartphone or tablet computer. When a program for a communication terminal in the virtual trial-fitting system is installed into the network device, the communication terminal T is configured. In the present embodiment, Wi-Fi (Wireless Fidelity) or a mobile telephone network is used to make a connection from the communication terminal T to the network N. In the present embodiment, the network N may use a LAN (Local Area Network), WAN (Wide Area Network), or the like, although it uses the Internet. The program for a server and the program for a communication terminal in the virtual trial-fitting system can be installed into the general-purpose computer via the network such as the Internet or the LAN. The programs can also be recorded on a recording medium such as a CD-ROM (Compact Disc Read Only Memory), a DVD-ROM (Digital Versatile Disk Read Only Memory), a flash memory, or a hard disk, and can also be installed via the recording medium.

### [Management Server]

The management server S includes a trial-fitting person information storage unit 11, a motion data storage unit 12, a clothes data storage unit 13, and an authentication unit 14. FIG. 3 illustrates respective structures of data (trial-fitting person information, motion data, and clothes data) respectively stored in the storage units. While each of the storage units are configured by a nonvolatile storage medium such as a hard disk and a DBMS (DataBase Management System) in the present embodiment, the DBSM is not necessarily required. While the storage units are confirmed on a single server S in the present embodiment, the storage units may be arranged while being dispersed among a plurality of servers. Particularly, information for each trial-fitting person (customer) is stored in the trial-fitting person information storage unit 11, as described below. Therefore, if the trial-fitting person information storage unit 11 is configured using an existing customer information management database, complexity of double management can be solved.

The trial-fitting person, storage unit 11 stores trial-fitting person, information for each trial-fitting person (customer). In the present embodiment, the trial-fitting person information includes identification information capable of specifying a trial-fitting person (hereinafter referred to as a trial-fitting person ID (Identifier)), three-dimensional body shape data of the trial-fitting person, and positional information about a feature point on the three-dimensional body shape data (hereinafter referred to as feature point position information) (see FIG. 3).

The trial-fitting person ID may be information capable of uniquely specifying the trial-fitting person. Particularly when a customer information management database is used, the trial-fitting person ID can also be set as a customer ID. Three-dimensional body shape data is three-dimensional shape data of the body of the trial-fitting person, and can be measured by a so-called body scanner. The feature point is a point whose position or the like changes depending on a body movement such as walking and a point used when clothes data is virtually put on among points on the body. For example, a point discussed in Patent Literature 2 can be used. The feature point may be automatically set when three-dimensional body shape data is acquired, or may be manually set by an operator after the acquired three-dimensional body shape data is displayed. Alternatively, the operator may correct the position of the feature point automatically set.

The feature point position information is three-dimensional coordinates of each of a plurality of feature points. Any position can be used as an origin in this case. For example, an origin in a world coordinate system optionally set may be used. Alternatively, one of the feature points can also be set as an origin.

An image of a face is preferably acquired when the three-dimensional body shape data is acquired and mapped into the three-dimensional body shape data when the trial-fitting image is generated. Generally, a person to be measured gets naked or wears such clothes that a body line becomes clear, e.g., underwear or a leotard to measure the three-dimensional body shape data. However, the three-dimensional body shape data may be measured while the person to be measured wears clothes to be worn simultaneously with clothes to be virtually tried on. In this case, an image of the clothes being worn is preferably acquired and mapped into the three-dimensional data when the trial-fitting image is generated. Thus, coordinates between existing clothes and virtual clothes data can be confirmed.

The motion data storage unit 12 stores a plurality of motion data. Each of the motion data includes identification information (hereinafter referred to as a motion ID) capable of uniquely specifying the motion data (hereinafter referred to as a motion ID), feature point movement information, and a description text (see FIG. 3). The feature point movement information represents a movement state of each of respective feature points at times when a body has performed a series of motions. The feature point used in the motion data corresponds to a feature point used in the trial-fitting person information. The motion data can be acquired, when a marker is attached to a position of a feature point on a model and the model performs a predetermined motion, as a three-dimensional position of the marker.

The feature point movement information in the present embodiment uses coordinates of each of the feature points at the times. When coordinates of a feature point pᵢ at a time tⱼ are expressed by pᵢ (tⱼ)=(xᵢ (tⱼ), yᵢ (tⱼ), zᵢ (tⱼ)), a feature point movement information is {j ∈{0, . . . , τ}: {i ∈{1, . . . , M}: Pᵢ (tⱼ)}}. Here, M is the number of feature points, and τ is the time length of the motion data. A method for representing the feature point movement information is not limited to this. Another representing method may be used. For example, coordinates of a feature point at a time 0 and a movement vector from the previous time of each of the feature points can also be used.

The description text is character information simply indicating how each of the motion data is acted, and is presented to the user of the virtual trial-fitting system when the motion data is selected. The motion ID is a value specific to each of the motion data. Therefore, the motion data can be searched for using the motion ID as a key.

The motion data can be generated from a motion of any person. That is, the motion data can also be generated from a motion of a model, or can also be generated from a motion of a trial-fitting person himself/herself. In the present embodiment, the motion data can be generated from a motion of a model other than the trial-fitting person.

The clothes data storage unit 13 stores a plurality of clothes data. Each of the clothes data includes identification information capable of uniquely specifying the clothes data (hereinafter referred to as a clothes ID) and three-dimensional shape data of clothes. In the present embodiment, a color and a pattern are registered as sub-data of each of the shape data. Therefore, the clothes data further includes a color and pattern ID and a thumbnail image. The color and pattern ID is identification information for specifying a color and a pattern. When clothes data is searched for using the clothes ID as a key, therefore, the acquired clothes data may have a plurality of colors and patterns. At this time, when clothes data whose color and pattern are even limited is desired to be acquired, the clothes ID and the color and pattern ID may be respectively used as search keys. The thumbnail image is image data obtained when the color and the pattern are added to the clothes having the three-dimensional shape data.

The authentication unit 14 performs authentication using identification information about a user that has been acquired by an identification information acquisition unit 21 in a communication terminal T, described below. Specifically, the authentication unit 14 determines whether or not trial-fitting person information having a trial-fitting person ID, which matches the identification information, is stored in the trial-fitting person information storage unit 11, to perform authentication. If the identification information acquisition unit 21 also acquires authentication information such as a password, authentication is performed depending on whether or not a pair of identification information and authentication information is stored in the trial-fitting person information storage unit 11. The authentication unit 14 notifies a control unit 20 in the communication terminal T of an authentication result, and the control unit 20 controls the communication terminal T to permit a trial-fitting operation only when authentication has been successfully performed.

### [Communication Terminal]

The communication terminal T includes the control unit 20, the identification information acquisition unit 21, a trial-fitting person information acquisition unit 22, a motion data acquisition unit 23, a clothes data acquisition unit 24, a motion data deformation unit 25, an motion body shape data generation unit 26, and a trial-fitting image generation unit 27. Where these functional units are configured by cooperation between a program according to the present invention, which has been read into the communication, terminal T, and a CPU (Central Processing Unit) in the present embodiment, they may be configured by hardware or hardware and software.

The control unit 20 controls the flow of processing by the entire communication terminal T, starting with adjustment of an operation timing of each of the functional units.

The identification information acquisition unit 21 acquires identification information about a user via a GUI (Graphical User Interface) and transmits it to the authentication unit 14 in the server S. Specifically, the identification information acquisition unit 21 displays an input form for inputting identification information such as a customer ID to a display D in the communication terminal T, and acquires identification information input by the user operating a touch panel TP. At this time, if the identification information acquisition unit 21 is configured to acquire not only the identification information but also authentication information such as a password, security can be enhanced. The identification information about the user acquired by the identification information acquisition unit 21 is sent to the authentication unit 14.

If the communication terminal T has its own terminal identification information, the trial-fitting person ID is set as terminal identification information about the communication terminal T. The identification information acquisition unit 21 can also be configured not to acquire identification information from the user but to transmit its own terminal identification information to the authentication unit 14 in the server S. Thus, user's convenience can be enhanced.

The trial-fitting person information acquisition unit 22 acquires trial-fitting person information about a user who has successfully been authenticated from the trial-fitting person information storage unit 11 in the server S using the identification information acquired by the identification information acquisition unit 21 as a key. Therefore, in the present embodiment, the user and a trial-fitting person become the same.

The motion data acquisition unit 23 acquires motion data from the motion data storage unit 12 in the server S. As a method for acquiring the motion data, all motion data can also be acquired at any timing. Alternatively, a motion ID is designated, and only the motion data having the motion ID can also be acquired. However, even in the latter case, motion IDs and description texts of all the motion data are desirably previously acquired.

The clothes data acquisition unit 24 acquires the clothes data from the clothes data storage unit 13 in the server S. The acquisition of the clothes data is similar to the acquisition of the motion data in that any data can be acquired at any timing. However, clothes IDs of all the clothes data and at least one thumbnail image associated with each of the clothes IDs are desirably previously acquired. Thus, the thumbnail images of all the clothes can be presented to the user.

The motion data deformation unit 25 deforms the motion data based on a feature point in the motion data and a feature point in three-dimensional body shape data of the user (trial-fitting person), and generates the deformed motion data. In other words, the motion data deformation unit 25 performs processing for generating the deformed motion data obtained by adapting the motion data to the body shape of the user. Specific processing will be described below.

The motion body shape data generation unit 26 generates motion body shape data using the deformed motion data and the three-dimensional body shape data. The motion body shape data is time series data obtained by moving the three-dimensional body shape data of the user depending on the deformed motion data.

The trial-fitting image generation unit 27 generates an image obtained by putting clothes on the motion body shape data (hereinafter referred to as a trial-fitting image). Specifically, the trial-fitting image generation unit 27 generates a three-dimensional shape in which three-dimensional shape data in selected clothes data is adapted to motion body shape data, and generates a two-dimensional image sequence obtained by seeing the three-dimensional shape from any viewpoint.

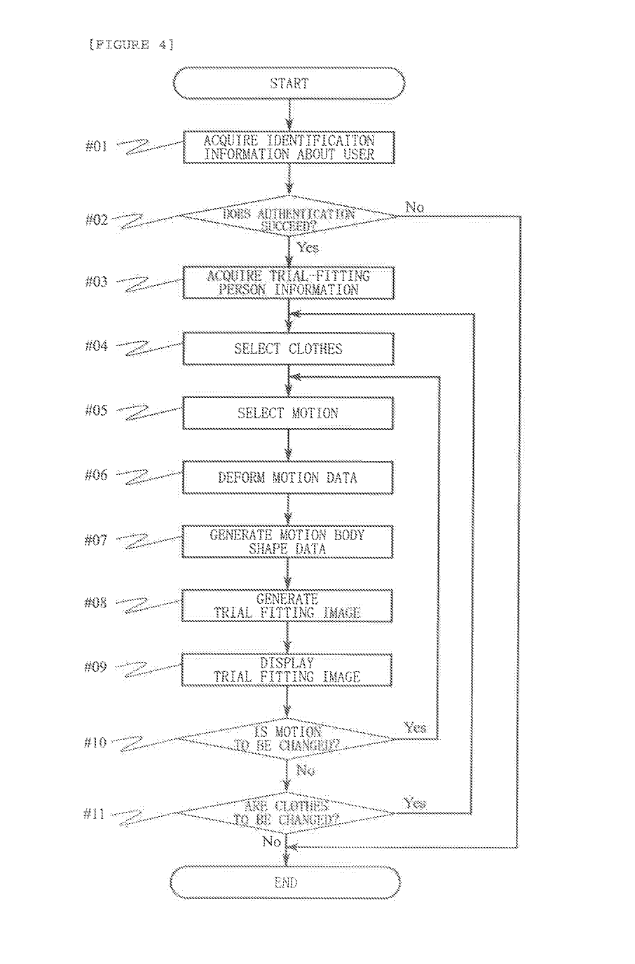

The flow of processing performed by the virtual trial-fitting system according to the present embodiment will be described below with reference to a flowchart of FIG. 4. As described above, motion data and clothes data are optionally acquired. Therefore, the motion data and the clothes data are respectively acquired by the motion data acquisition unit 23 and the clothes data acquisition unit 24 prior to the following processing.

When a user touches an icon for the virtual trial-fitting system via the touch panel TP, a program for the virtual trial-fitting system is loaded and started, and the following processing is executed.

The control unit 20 displays an input form into which identification information about a user (trial-fitting person) is input on the display D. The user operates the touch panel TP, and inputs identification information. The identification information acquisition unit 21 acquires the input identification information (#01). The identification information acquired by the identification information acquisition unit 21 is transmitted to the authentication unit 14 in the server S.

The authentication unit 14, which has acquired the identification information, authenticates the user (#02). Specifically, the authentication unit 14 accesses the trial-fitting person information storage unit 11 in the server S, and determines whether or not the same trial-fitting person ID as the acquired identification information has been registered. If the same trial-fitting person ID as the acquired identification information has been registered in the trial-fitting person information storage unit 11, the authentication unit 14 notifies the control unit 20 that the authentication has been successfully performed (YES in #02). On the other hand, if the same trial-fitting person ID as the acquired identification information has not been registered, the authentication unit 14 notifies the control unit 20 that the authentication has been unsuccessfully performed (No in #02).

If the authentication has been successfully performed, the control unit 20 instructs the trial-fitting person information acquisition unit 22 to acquire trial-fitting person information about the user (=trial-fitting person) who has been successfully authenticated from the trial-fitting person information storage unit 11 in the server S. The trial-fitting person information acquisition unit 22, which has received the instruction, acquires the trial-fitting person information from the trial-fitting person information storage unit 11 using the identification information acquired by the identification information acquisition unit 21 as a search key (#03).

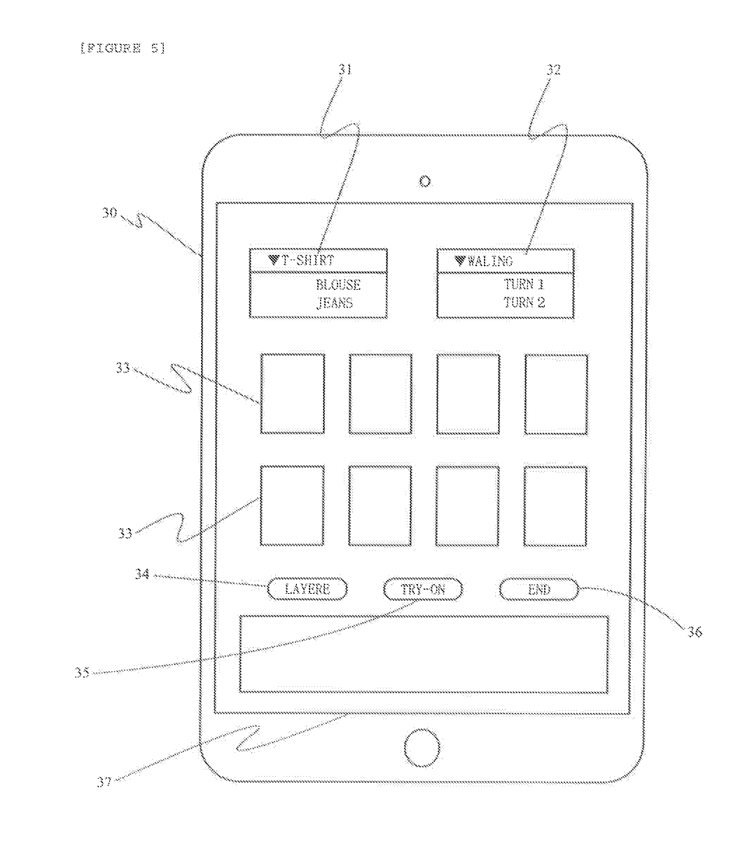

The control unit 20 then displays a data selection picture 30 illustrated in FIG. 5 on the display D to cause the user to select data used for virtual trial-fitting. The data selection picture 30 includes a clothes selection menu 31 for selecting the type of clothes and a motion selection menu 32 for selecting a motion. The clothes selection menu 31 and the motion selection menu 32 can be respectively configured as pull-down menus, and are both displayed while being pulled down in FIG. 5. The data selection picture 30 includes respective thumbnail images 33 of a plurality of clothes.

In the present embodiment, the type of clothes is determined depending on a first character of a clothes ID of the clothes. The type of clothes is a T-shirt if the clothes ID is 1 [0-9] +, is a blouse if it is 2 [0-9] +, and is jeans if it is 3 [0-9] +, for example. If the user operates the clothes selection menu 31 via the touch panel TP, to select the T-shirt, the control unit 20 selects clothes data with a clothes ID =1 [0-9] +, and thumbnail images included in the selected clothes data are displayed as a list on the display D. Naturally, the type of clothes that can be used in the virtual trial-fitting system is not limited to these. The type of clothes may be a kimono, a swimming suit, underwear, or the like. The clothes data in the present embodiment may include thumbnail images respectively having different colors (patterns), as described above. In the case, the thumbnail images respectively having different colors (patterns) are not simultaneously displayed. Only the thumbnail image being typical (e.g., with a minimum color and pattern ID) is displayed, to preferably indicate that there are clothes having a different color (pattern).

The user operates, for the plurality of thumbnail images 33 thus displayed, the touch panel TP to touch the one thumbnail image 33, to select desired clothes (#04). The selected thumbnail image 33 is displayed on a selected clothes display region 37.

The user operates the touch panel TP, to select one motion (#05). In an example in the figure, walking is selected.

The user operates the touch panel TP to touch a try-on button 35 when clothes and a motion have been selected. The control unit 20 performs virtual trial-fitting processing, described below, when it detects the touch of the trial-fitting button 35. In the present embodiment, a plurality of layers of clothes can be worn. For example, a T-shirt and jeans can be virtually tried on. In this case, a layer button 34 is touched with the thumbnail image 33 corresponding to the T-shirt selected, to select jeans from the clothes selection menu 31 and select the thumbnail image 33 corresponding to the jeans. Then, the try-on button 35 is touched. Naturally, the number of layers of clothes may be two or more. Even if the number of layers of clothes is increased, each of the selected thumbnail images is displayed in the selected clothes display region 37. Therefore, the user can easily confirm the selected clothes.

When the try-on button 35 is touched, the control unit 20 notifies the motion data deformation unit 25 of a motion ID associated with the selected motion. The motion data deformation unit 25, which has received the notification, deforms motion data with the notified motion ID (#06). In other words, the motion data deformation unit 26 performs processing for adapting the motion data to three-dimensional body shape data of a trial-fitting person based on a positional relationship between a feature point in the motion data and a feature point set on three-dimensional body shape data of the trial-fitting person. Specifically, the following processing is performed.

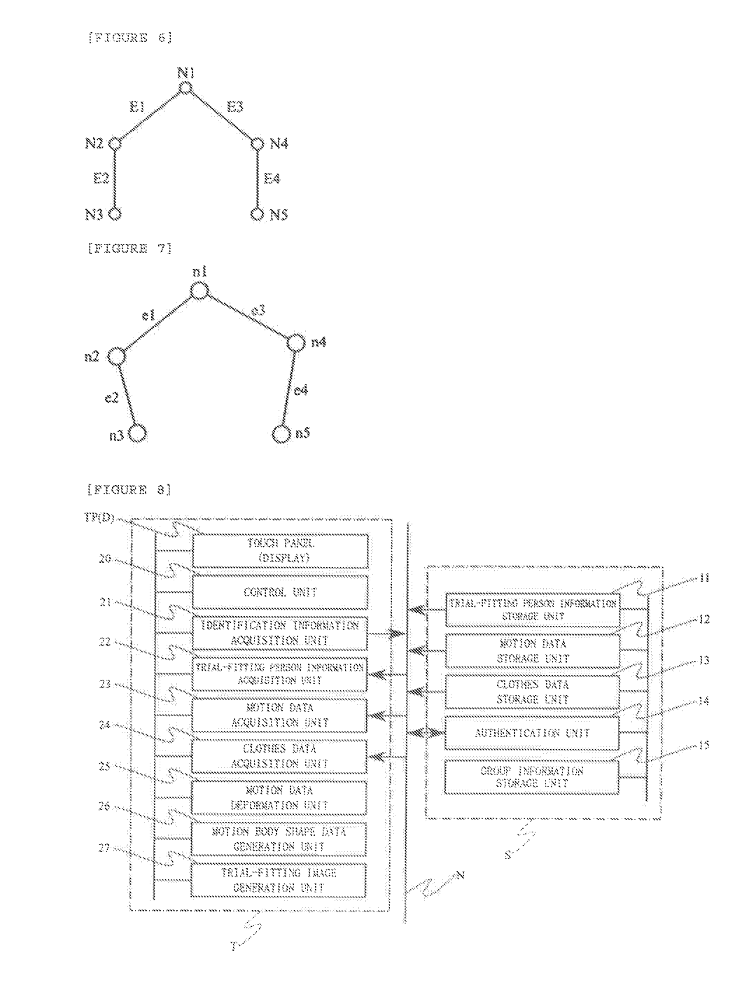

Feature points in the present embodiment are represented by a graph structure, as illustrated in FIGS. 6 and 7. That is, feature points are respectively nodes, and each of the nodes has an edge for the adjacent feature point. Each of FIGS. 6 and 7 illustrates a part of a graph structure of feature points set on three-dimensional body shape data and as part of a graph structure of feature points set in motion data at one time corresponding thereto. While each of nodes is connected to an adjacent node via one or two edges for simplification in the present embodiment, the nodes may be adjacent to each other via a larger number of edges. For example, a node Ml is connected to nodes N2 and N4, respectively, via edges E1 and E3. On the other hand, a node N3 is connected to the node N2 via an edge E2 . Nodes Ni and ni respectively have three-dimensional coordinates Pᵢ (Xᵢ, Yᵢ, Zᵢ) and pᵢ (xᵢ, yᵢ, zᵢ).

The motion data deformation unit 25 adapts the motion data to the three-dimensional body shape data of the trial-fitting person by deforming the graph structure illustrated in FIG. 7 using the graph structure illustrated in FIG. 6. First, the motion data deformation unit 25 selects one node from the graph structure in the three-dimensional body shape data, and selects a node corresponding to the node from the graph structure in the motion data. The selected node is hereinafter referred to as a reference node. When the node N1 is selected from the three-dimensional body shape data, for example, a node n1 is selected from the motion data.

Then, nodes adjacent to the reference node (hereinafter referred to as adjacent nodes) are sequentially selected. Here, the node N2 and a node n2 corresponding thereto are set as adjacent nodes. A distance between the reference node and the adjacent node is calculated. In the three-dimensional body shape data, a distance between the reference node N1 and the adjacent node N2 (the length of the edge E1) L₁ is expressed by the following equation:

L₁={(X₂−X₁)²+(Y₂−Y₁)²+(Z₂−Z₁)²}^{1/2}

On the other hand, in the motion data, a distance between the reference node n1 and the adjacent node n2 (the length of an edge e1) l₁ is expressed by the following equation:

l₁={(x₂−x₁)²+(y₂−y₁)²+(z₂−z₁)²}^{1/2}

The motion data deformation unit 25 then moves the node n2, i.e., a feature point p₂ to p₂′ so that the length of the edge e1 becomes equal to the length of the edge E1. Specifically, the following equation holds:

P₂′=(x₂, y₂, z₂)×L₁/l₁

As the node n2 (the feature point p₂) moves, a node (a feature point) directly or indirectly connected no the node n2 also similarly moves. That is, a node n3 moves in parallel with the node n2 by the same amount.

The motion data deformation unit 26 then sets an adjacent node as a reference node, to perform similar processing to that described above. That is, the node N2 and the node n2 are respectively set as reference nodes, to move the node n3 (a feature point p₃). This processing is recursively performed until there is no node adjacent to the reference node.

Similar processing to that for the node n2 is also performed for another node n4 adjacent to the reference node n1. Further, this processing is performed for the motion data at each of the times.

By the aforementioned processing, the position of the feature points in the motion data are changed based on the length between the adjacent feature points on the three-dimensional body shape data of the trial-fitting person, and the motion data can be adapted to the three-dimensional body shape data of the trial-fitting person. The processing for deforming the motion data is not limited to this. Another method may be used.

When the motion data is generated from the motion of the trial-fitting person, the motion data deformation unit 26 may not be provided. Alternatively, the motion data deformation unit 26 may be configured to through-output the motion data.

When the deformation of the motion data is completed, the control unit 20 instructs the motion body shape data generation unit 26 to generate motion body shape data, and the motion body shape data generation unit 26, which has received the instruction, generates the motion body shape data (#07). The motion body shape data generation unit 26 generates motion body shape data obtained by moving the three-dimensional body shape data of the trial-fitting person based on the motion data adapted to the three-dimensional body shape data of the trial-fitting person by motion data deforming unit 25. For example, an edge connecting a feature point (a node) and an adjacent feature point is grasped as a skeleton, and the three-dimensional body shape data is deformed depending on coordinates (a skeleton position) of the feature point at each of the times. This enables the three-dimensional body shape data of the trial-fitting person to perform a similar motion to that of the model. The generation of the motion body shape data is not limited to this. Another method may be used.

When the generation of the motion body shape data is completed, the control unit 20 notifies the trial-fitting image generation unit 27 of a clothes ID of selected clothes, and the trial-fitting image generation unit 27, which has received the notification, generates a trial-fitting image (#08). Specifically, the following processing is performed.

The trial-fitting image generation unit 27 first acquires three-dimensional shape data of the clothes having the notified clothes ID. The trial-fitting image generation unit 27 then generates three-dimensional shape data obtained by putting the clothes on the three-dimensional body shape data at each of the times in the motion body shape data, and maps a color and a pattern of the clothes into a portion of the clothes in the three-dimensional shape data. To virtual put the clothes on the three-dimensional body shape data, the technique in the aforementioned Patent Literature can be used.

The trial-fitting image generation unit 27 generates a series of two-dimensional images obtained by seeing the three-dimensional shape data at each of the times from a predetermined viewpoint as a trial-fitting image.

When the generation of the trial-fitting image is completed, the control unit 20 displays a series of trial-fitting images on the display D (#03). At this time, a user interface for inputting a viewpoint position is formed on the display D, to enable a user to input the viewpoint position by operating the touch panel TP, The trial-fitting image generation unit 27 is notified of the input viewpoint position, and generates a two-dimensional trial-fitting image as viewed from the notified viewpoint again.

When a user is to select different clothes and a different motion (YES in #10 and #11), a similar selecting operation to that described above can be performed upon returning to the data selection picture 30 illustrated in FIG. 5. If the user is to change only a color and a pattern of the clothes, a color selection menu can be displayed when the user holds down the thumbnail image 33, for example. If only the color and the pattern of the clothes have been changed, the trial-fitting image generation unit 27 can preferably reduce a calculation amount when the color and the pattern are only mapped.

If the virtual trial-fitting system according to the present embodiment is thus used, the clothes can be virtually tried on with the motion data previously registered adapted to the trial-fitting person. Thus, a trial-fitting state occurring when various motions are performed with the clothes actually tried on can be confirmed without the clothes tried on.

### Embodiment 2

A virtual trial-fitting system in an embodiment 2 differs from that in the embodiment 1 in that a user and a trial-fitting person differ from each other. That is, in the virtual trial-fitting system according to the present embodiment can perform virtual trial-fitting for a third person.

Therefore, trial-fitting person information in the present embodiment includes identification information about a person to be permitted (hereinafter referred to as a person-to-be-permitted ID) in addition to a trial-fitting person ID, three-dimensional body shape data, and feature point position information. The person-to-be-permitted ID is identification information about a person who has been permitted to perform a trial-fitting operation from a trial-fitting person. That is, the person to be permitted can perform a virtual trial-fit ting operation using the three-dimensional body shape data of the trial-fitting person serving as the third person. The trial-fitting person information need not be retained in a single table. If a permission relationship between the trial-fitting person and the user can be grasped, the trial-fitting person information may be retained in another form. A plurality of person-to-be-permitted IDs may be set for one trial-fitting person information.

A functional block of the virtual trial-fitting system according to the present embodiment is similar to that in the embodiment 1, and hence detailed description is omitted and only a different portion will be described.

Functional units in the present embodiment and the functional units in the embodiment 1 differ from each other in an identification information acquisition unit 21 and an authentication unit 14. The identification information acquisition unit 21 in the present embodiment acquires identification information about a user (hereinafter referred to as a user ID) and identification information about a trial-fitting person (a trial-fitting person ID), and transmits the identification informations to the authentication unit 14 in a server S.

In the authentication unit 14, which has received the user ID and the trial-fitting person ID, trial-fitting person information is first searched for using the trial-fitting person ID as a key. At this time, when corresponding trial-fitting person information cannot be searched for, a communication terminal T is notified that authentication has been unsuccessfully performed. On the other hand, when corresponding trial-fitting person information can be searched for, a person-to-be-permitted ID of the trial-fitting person information searched for and the user ID received from the communication terminal T are collated with each other. At this time, the authentication unit 14 notifies the communication terminal T that authentication has been successfully performed if the person-to-be-permitted ID and the user ID match each other, and notifies the communication terminal T that authentication has been unsuccessfully performed if the person-to-be-permitted ID and the user ID do not match each other.

The communication terminal T (a control unit 20), which has received an authentication result from the authentication unit 14, perform virtual trial-fitting using the three-dimensional body shape data in the trial-fitting person information if an authentication result is “success”, like in the embodiment 1. On the other hand, if an authentication result is “failure”, the processing ends, to return to display of an input picture for identification information, for example.

Thus, in the virtual trial-fitting system according to the present embodiment, the user can perform virtual trial-fitting using three-dimensional body shape data of a third person such as a family or a lover. When clothes are presented to the family, the lover, or the like, therefore, clothes suiting the other person can be selected without being known to the other person.

### Embodiment 3

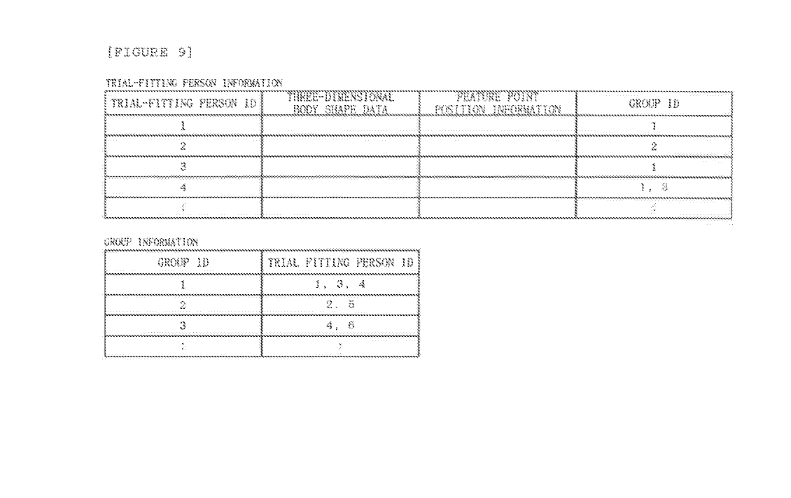

A virtual trial-fitting system according to the present embodiment differs from those in the aforementioned embodiments in that virtual trial-fitting for a plurality of persons (groups) can be performed. Therefore, the virtual trial-fitting system according to the present embodiment differs from that in the embodiment 1 in that a server S includes a group information storage unit 15, as illustrated in a functional block diagram of FIG. 8.

Trial-fitting person information in the present embodiment includes a group ID, as illustrated in FIG. 9. The group ID indicates in which group each of trial-fitting persons belongs. For example, a trial-fitting person with a trial-fitting person ID=1 belongs to a group with a group ID=1. On the other hand, a trial-fitting person with a trial-fitting person ID=4 belongs to respective groups with a group ID=1 and a group ID=3. Thus, each of the trial-fitting persons can belong to a plurality of groups.

The group information storage unit 15 stores group information as illustrated in FIG. 9. The group information includes a group ID for identifying groups and a trial-fitting person ID of a trial-fitting person belonging to each of the groups. The group information is information that can be generated from the trial-fitting person information. When the group information is previously stored, however, processing during authentication can be reduced. The virtual trial-fitting system can have a configuration in which the group information storage unit 15 is not provided. However, in the case, a trial-fitting person information storage unit 11 or a memory or the like storing group information temporarily generated functions as a group information storage unit in the present invention.

Other functional units are similar to those in the embodiment 1, and hence description thereof is not repeated. Processing of the virtual trial-fitting system in the present embodiment mainly differs from the processing in the embodiment 1 in processing performed by a trial-fitting person information acquisition unit 22. In the following description, such a different portion will be described.

First, an authentication unit 14 performs authentication based on identification information from an identification information acquisition unit 21, and an authentication result is transmitted to a control unit 20, like in the embodiment 1. The control unit 20 sends an instruction to acquire trial-fitting person information to the trial-fitting person information acquisition unit 22 when the authentication has been successfully performed.

The trial-fitting person information acquisition unit 22, which has received the instruction from the control unit 20, acquires the trial-fitting person information from the trial-fitting person information storage unit 11 using the identification information acquired by the identification information acquisition unit 21 as a key. Further, in the present embodiment, the group information is acquired from the group information storage unit 15 using the group ID in the acquired trial-fitting person information as a key. When the trial-fitting person ID is 1, for example, group information {1, 3 , 4, } with a group ID=1 is searched for. If the trial-fitting person information has a plurality of group IDs, like trial-fitting person information with a trial-fitting person ID=4, the control unit 20 controls a display D and a touch panel TP, to preferably cause a user to select a desired group.

Further, the trial-fitting person information acquisition unit 22 acquires trial-fitting person information corresponding to the trial-fitting person ID in the acquired group information from the trial-fitting person information storage unit 11. In the aforementioned example, respective trial-fitting person information corresponding to trial-fitting person IDs 3 and 4 are acquired.

Thus, in the virtual trial-fitting system according to the present embodiment, a plurality of trial-fitting person information are acquired. Similar trial-fitting processing to that in the embodiment 1 is performed for three-dimensional body shape data included in each of the trial-fitting person information. Naturally, clothes can be selected for each trial-fitting person, and motion data including respective motions of a plurality of persons is used. A user interface for causing a user to specify which of the motions corresponds to any one of the trial-fitting persons is preferably provided.

Specifically, a motion data deformation unit 25 adapts an motion of each of models included in motion data to three-dimensional body shape data of a corresponding trial-fitting person, and an motion body shape data generation unit 26 generates motion body shape data including respective motion body shapes of a plurality of trial-fitting persons based on each of deformed motions and the three-dimensional body shape data of the corresponding trial-fitting person. A trial-fitting image generation unit 27 generates a trial-fitting image obtained by virtually putting clothes on a motion body shape of each of the trial-fitting persons in this motion body shape data.

Thus, in the virtual trial-fitting system according to the present embodiment, a single trial-fitting image can include respective trial-fitting states of a plurality of persons such as a family or lovers. Therefore, total coordinates of clothes of the plurality of persons can be easily performed. In this case, when a plurality of trial-fitting persons gather to discuss, the virtual trial-fitting system is expected to also function as a communication tool.

While the virtual trial-fitting system includes the server S and the communication terminal T in the present embodiment, a system configuration is not limited to this. An arrangement of the functional units can be changed, as needed. For example, the functional units can also be dispersed among more devices. Alternatively, all the functional units can also be arranged in a single device.

While actual measurement data of the trial-fitting person is used as the three-dimensional body shape data in the aforementioned embodiments, the three-dimensional body shape data may be set using another method. For example, three-dimensional body shape data closest to the body shape of a trial-fitting person is selected among a plurality of three-dimensional body shape data previously registered in the system, and the selected three-dimensional body shape data can be used as three-dimensional body shape data of the trial-fitting person. Alternatively, numerical data relating to the body shape of a trial-fitting person is input, and three-dimensional body shape data can also be generated from the input numerical data. Naturally, the three-dimensional body shape data set using the methods do not strictly represent the body shape of the trial-fitting person. However, time and labor to acquire the three-dimensional body shape data can be reduced, and an appropriate trial-fitting state can be confirmed.

The present invention can be used for a virtual trial-fitting technique for virtually trying on clothes on three-dimensional body shape data.

1. A virtual trial-fitting system for causing a trial-fitting person to virtually try on clothes, comprising:
a trial-fitting person information storage unit storing trial-fitting person information including three-dimensional body shape data of the trial-fitting person and a position of a feature point set on the three-dimensional body shape data;
a motion data storage unit storing motion data representing a three-dimensional position of a feature point of a human body at each of times;
a clothes data storage unit storing clothes data including shape data of the clothes;
a trial-fitting person information acquisition unit that acquires the trial-fitting person information;
a motion data acquisition unit that acquires the motion data;
a motion data deformation unit that deforms the motion data at each of the times to be adapted to the three-dimensional body shape data of the trial-fitting person based on a positional relationship between the feature point in the motion data at the time and the feature point set on the three-dimensional body shape data of the trial-fitting person;
a motion body shape data generation unit that generates motion body shape data obtained by moving the three-dimensional body shape data of the trial-fitting person in a three-dimensional manner based on the deformed motion data;
a clothes data acquisition unit that acquires the clothes data from the clothes data storage unit; and
a trial-fitting image generation unit that generates a trial-fitting image obtained by virtually putting the clothes on the three-dimensional body shape data at each of the times of the motion body shape data based on the clothes data.

2. The virtual trial-fitting system according to claim 1, wherein the motion data deformation unit moves the position of the feature point in the corresponding motion data based on a distance between the adjacent feature points among the feature points set on the three-dimensional body shape data of the trial-fitting person.

3. The virtual trial-fitting system according to claim 1, wherein the trial-fitting person information includes identification information about a person to be permitted to perform an operation for generating the trial-fitting image by the trial-fitting person, further comprising
an identification information acquisition unit that acquires identification information about a user, and
a control unit that performs control to permit the operation for generating the trial-fitting image only for the trial-fitting person information including the identification information about the user as the identification information about the person to be permitted.

4. The virtual trial-fitting system according to claim 1, further comprising
a group information storage unit storing group information, for defining information about the trial-fitting persons belonging to the same group,
wherein the trial-fitting person Information acquisition unit acquires the trial-fitting person information about the trial-fitting persons belonging to the same group,
respective motions of a plurality of persons are defined in the motion data, and
the trial-fitting image generation unit generates the trial-fitting images respectively including virtual trial-fitting states of the trial-fitting persons belonging to the same group.

5. (canceled)

6. A virtual trial-fitting method for causing a trial-fitting person to virtually trial-fit clothes, comprising:
a trial-fitting person information acquisition step of acquiring previously stored trial-fitting person information including three-dimensional body shape data of the trial-fitting person and a position of a feature point set on the three-dimensional body shape data;
a motion data acquisition step of acquiring previously stored motion data representing a three-dimensional position of a feature point of a. human body at each of times;
a motion data deformation step of deforming the motion data at each of the times to be adapted to the three-dimensional body shape data of the trial-fitting person based on a positional relationship between the feature point in the motion data at the time and the feature point set on the three-dimensional body shape data of the trial-fitting person;
a motion body shape data generation step of generating motion body shape data obtained by moving the three-dimensional body shape data of the trial-fitting person in a three-dimensional manner based on the deformed motion data; and
a clothes data acquisition step of acquiring previously stored clothes data including shape data of the clothes; and
a trial-fitting image generation step of generating a trial-fitting image obtained by virtually putting the clothes on the three-dimensional body shape data in each of frames of the motion body shape data based on the clothes data.

7. A computer readable storage medium storing a virtual trial-fitting program for a virtual trial-fitting system for causing a trial-fitting person to virtually trial-fit clothes, the virtual trial-fitting program causing a computer to implement:
a trial-fitting person information acquisition function for acquiring, from a trial-fitting person information storage unit storing trial-fitting person information including three-dimensional body shape data of the trial-fitting person and a position of a feature point set on the three-dimensional body shape data, the trial-fitting person information;
a motion data acquisition function for acquiring, from a motion data storage unit storing motion data representing a three-dimensional position of a feature point of a human body at each of times, the motion data;
a motion data deformation function for deforming the motion data at each of the times to be adapted to the three-dimensional body shape data of the trial-fitting person based on a positional relationship between the feature point in the motion data at the time and the feature point set on the three-dimensional body shape data of the trial-fitting person;
a motion body shape data generation function for generating motion body shape data obtained by moving the three-dimensional body shape data of the trial-fitting person in a three-dimensional manner based on the deformed motion data; and
a clothes data acquisition function for acquiring the clothes data from a clothes data storage unit storing clothes data including shape data of the clothes; and
a trial-fitting image generation function for generating a trial-fitting image obtained by virtually putting the clothes on the three-dimensional body shape data in each of frames of the motion body shape data based on the clothes data.

8. The virtual trial-fitting system according to claim 2, wherein the trial-fitting person information Includes identification information about a person to be permitted to perform an operation for generating the trial-fitting image by the trial-fitting person, further comprising
an identification information acquisition unit that acquires identification information about a user, and
a control unit that performs control to permit the operation for generating the trial-fitting image only for the trial-fitting person information including the identification information about the user as the identification information about the person to be permitted.

9. The virtual trial-fitting system according to claim 2, further comprising
a group information storage unit storing group information for defining information about the trial-fitting persons belonging to the same group,
wherein the trial-fitting person information acquisition unit acquires the trial-fitting person information about the trial-fitting persons belonging to the same group,
respective motions of a plurality of persons are defined in the motion data, and
the trial-fitting image generation unit generates the trial-fitting images respectively including virtual trial-fitting states of the trial-fitting persons belonging to the same group.

10. The virtual trial-fitting system according to claim 3, further comprising
a group information storage unit storing group information for defining information about the trial-fitting persons belonging to the same group,
wherein the trial-fitting person information acquisition unit acquires the trial-fitting person information about the trial-fitting persons belonging to the same group,
respective motions of a plurality of persons are defined in the motion data, and
the trial-fitting image generation unit generates the trial-fitting images respectively including virtual trial-fitting states of the trial-fitting persons belonging to the same group.

11. The virtual trial-fitting system according to claim 8, further comprising
a group information storage unit storing group information for defining information about the trial-fitting persons belonging to the same group,
wherein the trial-fitting person information acquisition unit acquires the trial-fitting person information about the trial-fitting persons belonging to the same group,
respective motions of a plurality of persons are defined in the motion data, and
the trial-fitting image generation unit generates the trial-fitting images respectively including virtual trial-fitting states of the trial-fitting persons belonging to the same group.
